(19) United States
(12) Patent Application Publication
(10) Pub. No.: US 2014/0006261 A1
(43) Pub. Date: Jan. 2, 2014

(54) SYSTEMS AND METHODS FOR CONDUCTING A QUICK TRANSACTION

(71) Applicant: SERVE VIRTUAL ENTERPRISES, INC., St. Petersburg, FL (US)

(72) Inventors: Jason Hogg, St. Petersburg, FL (US); Nick Johns, St. Petersburg, FL (US); Corey Moreira, St. Petersburg, FL (US); Andrew Peret, St. Petersburg, FL (US); Burak Seren, St. Petersburg, FL (US)

(73) Assignee: SERVE VIRTUAL ENTERPRISES, INC., St. Petersburg, FL (US)

(21) Appl. No.: 13/690,878

(22) Filed: Nov. 30, 2012

Related U.S. Application Data
(63) Continuation-in-part of application No. 13/540,216, filed on Jul. 2, 2012.

(51) Int. Cl. G06Q 20/22

(52) U.S. Cl. CPC G06Q 20/22
USPC 705/39

(57) ABSTRACT

The disclosure includes comprehensive system and methods for enabling customer acquisition by enabling transactions without requiring a cumbersome, time-consuming registration process. The system includes logic engines, databases, interconnectivity with social networking services and financial institutions and customizable financial account creation processes. The system enables capturing purchaser information in a shell account without requiring a customer to register for a full account of a value transfer service.

### RELATED APPLICATIONS

This application claims priority to U.S. patent application Ser. No. 13/540,216 entitled “Systems and Methods for Transferring Value via a Social Network,” filed on Jul. 2, 2012, and which is hereby incorporated by reference in its entirety for all purposes.

### FIELD

The present disclosure generally relates to enabling financial transactions to be completed with various levels of accounts and various amounts of account information.

### BACKGROUND

Online or electronic commerce has become a large part of the global economy. In order to accommodate electronic commerce, financial institutions and other service providers have developed new forms of online account services such as value transfer accounts and services. Often, value transfer services rely on large or growing customer account bases in order to drive transactions through the service and to produce ancillary revenue through, for example, upsell opportunities. As such, such value transfer services often include a potential customer fully registering for a service prior to taking advantage of any of the service offerings (e.g., conducting online purchases or executing a person to person value transfer). However, registration processes tend to be time consuming and often request detailed information. Therefore, value transfer services often lose many potential customers because of abandonment (e.g. failure to complete) an online registration process.

As such a long felt need exists for an integrated, end-to-end, automated system that enables the ability to engage a customer and enable a transaction, while including minimal information and using the minimal information to enable a future streamlined registration process.

### SUMMARY

Methods and systems enable a user to complete a transaction without fully registering for (or with minimal registration for) a value transfer service. In various embodiments, a value transfer computer associated with a value transfer service receives a first transaction request from a purchaser. The first transaction request may be associated with a first offer. The value transfer computer receives purchaser information that may include a purchaser name and a purchaser email. The value transfer computer determines that the purchaser is not registered with the value transfer service and prompts the purchaser for transaction account data. The value transfer service receives transaction account data (e.g. from the purchaser) and completes a transaction associated with the first transaction request. The value transfer service associates a shell account with the purchaser information and/or the transaction account data.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and:

FIG. 1 is a block diagram illustrating major system components of a value transfer service system, in accordance with various embodiments; and

FIG. 2 is a flow chart illustrating an exemplary process for creating a shell account, in accordance with various embodiments.

### DETAILED DESCRIPTION

The systems and methods provide an improved, automated and integrated system for attracting, registering and retaining customers for an online value transfer service (“VTS”). A “value transfer service” may include any entity that facilitates the transfer of value (e.g., money, currency, points, credits, coupons, etc) from a sender to a receiver. Various embodiments of the value transfer service may be implemented by a system, computer readable medium, internet based system, a method or any combination thereof. The systems and methods include a unique combination of one or more features associated with online marketing, value transfer, customer acquisition and customer retention.

“Entity” may include any individual, consumer, customer, purchaser, seller, group, business, organization, government entity, transaction account issuer or processor (e.g., credit, charge, etc), merchant, consortium of merchants, account holder, charitable organization, software, hardware, and/or any other entity.

An “account”, “account number” or “account identifier ” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a stored value account, rewards account, charge account, credit account, debit account, prepaid account, telephone card, embossed card, smart card, magnetic stripe card, bar code card, transponder, radio frequency card or an associated account.

Account number may be distributed and stored in any form of plastic, electronic, magnetic, radio frequency, wireless, audio and/or optical device capable of transmitting or downloading data from itself to a second device, An account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing batik, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), biometric, and the like.

The system may include or interface with any of the accounts or devices discussed herein, or a transponder and REID reader in RE communication with the transponder (which may include a fob). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc.

The account number may be distributed and stored in any form of plastic, electronic, magnetic, radio frequency, wireless, audio and/or optical device capable of transmitting or downloading data from itself to a second device. A consumer account code may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

A “transaction account” may include any account that may be used to facilitate a financial transaction. A financial institution or transaction account issuer includes any entity that offers transaction account services to consumers. Although often referred to as a “financial institution,” the financial institution may represent any type of bank, lender or other type of account issuing institution, such as credit card companies, card sponsoring companies, or third party issuers under contract with financial institutions, It is further noted that other participants may be involved in some phases of the transaction, such as an intermediary settlement institution, but these participants are not shown.

A “processor”, “financial processor,” “payment network,” “payment system” or “transaction account issuer” may include any entity which processes transactions, issues accounts, acquires financial information, settles accounts, conducts dispute resolution regarding accounts, and/or the like.

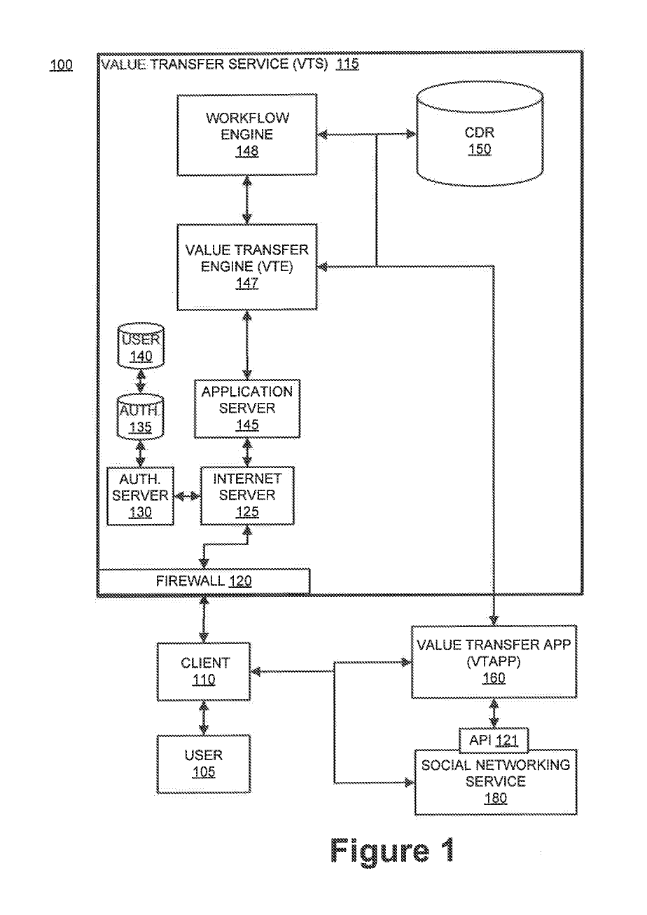

FIG. 1 shows an exemplary block diagram illustrating major system components for enabling VTS 115. System 100 facilitates interaction between a user 105 and VTS 115 through, in various embodiments, client 110 with a network connection to an Internet server 125 by way of the Internet. In various embodiments, Internet server 125 employs authentication server 130 to validate credentials, assign proper permissions, and retrieve preferences information for authorized user's 105 of VTS 115.

In various embodiments, Internet server 125 employs application server 145 to manage various applications and utilities that are utilized by system 100. In various embodiments, application server utilizes APL+Win, MOSS utilizing SEAM, Richfaces JBPM, and/or other Java libraries (jQuery and Javascript), JAX-WS, Apache POI, and/or Quartz. In various embodiments, Internet server 125 interacts directly with the various systems and components disclosed herein.

VTS 115 may include any number of computing platforms and databases such as, for example, value transfer engine (“VTE”) 147, workflow engine 148 and central data repository (“CDR”) 150. Other systems may include, for example, social networking systems, accounting systems, financial transaction systems, reporting systems, new accounts systems, management information systems, business information systems, external data sources, proprietary systems and the like. Each of the systems may be interconnected within by a network in via any method and/or device described herein, A middleware server and/or application server 145 may serve as an intermediary between the various systems to ensure appropriate communications between disparate platforms. A report engine retrieves and/or is provided with data from certain of the various systems in order to generate notices, offers, bills, messages, audit reports, and the like.

System 100, VTS 115 and/or any other components discussed herein may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; as display device coupled to the processor and memory for displaying information derived from digital data processed by the processor; and a plurality of databases.

As will be appreciated by one of ordinary skill in the art, one or more of the components of system 100 may be embodied as a customization of an existing system, an add-on product, a processing apparatus executing upgraded software, a stand-alone system, a distributed system, as method executed by a computer, a data processing system, a device for data processing, and/or a computer program product. Accordingly, any portion of the system or a module may take the form of a processing apparatus executing code, an internet based embodiment, an entirely hardware embodiment, or an embodiment combining aspects of a network (e.g., the internet), software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system contemplates uses in association with web services, transaction processing, utility^{,} computing, pervasive and individualized computing, security and identity solutions, autonomic computing, commodity computing, mobility and wireless solutions, open source, biometrics, grid computing and/or mesh computing.

User 105 may include any entity that utilizes system 100 or VTS 115 functionality. User 105 may include, for example, a user that receives an offer and wishes to take advantage of (e.g. purchase) the over via a value transfer service.

In various embodiments, VTAPP 160 accesses social networking service 180 via API 121. In various embodiments, user 105 may interface with VTS 115, social networking service 160 and/or VTAPP 160 via any communication protocol, device or method discussed herein or known in the art. For example, user 105 may interact with VTS 115 by way of an app or a social networking service.

Client 110 comprises any hardware and/or software suitably configured to facilitate requesting, retrieving, updating, analyzing, entering and/or modifying data. For example, in various embodiments, client 110 is configured to facilitate input, receipt, presentations, analysis and/or review of information relating to social networking services, value transfer services, etc. Client 110 includes any device (e.g., personal computer) which communicates (in any manner discussed herein) with VTS 115, VTAPP 160 and/or social networking service 180 via any network discussed herein. Such browser applications comprise Internet browsing software and/or apps installed within a computing unit or system to conduct online transactions and/or communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that client 110 may or may not be in direct contact with VTS 115 or VTAPP 160. For example, client 110 may access the services of TTS 115 through another server, which may have a direct or indirect connection to Internet server 125. Client 110 may access VTAPP 160 via social networking service 180. Client 110 may be mobile or may be located in a home or business environment with access to a network. In an embodiment, access is through a network or the Internet through a commercially-available web-browser software package.

As those skilled in the art will appreciate, client 110 includes an operating system (e.g., Windows NT, 95/98/2000, OS2, UNIX, Linux, Solaris, MacOS, Android, iPhone OS etc.) as well as various conventional support software and drivers typically associated with computers, or computing devices. Client 110 may include any suitable personal computer, mobile device, phone, smart phone, network computer, workstation, minicomputer, mainframe or the like. Client 110 can be in a home or business environment with access to a network.

In various embodiments, various components, modules, and/or engines of system 100 may be implemented as micro-applications or “apps.” In various embodiments, VTAPP 160 is a micro-app that runs on client 110 (e.g. a mobile device). Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request as response from the operating system which monitors various hardware components and then communicates a detected input from the hardware to the micro-app.

Client 110 may be independently, separately or collectively suitably coupled to the network via data links which includes, for example, a connection to a wireless service provider or an Internet Service Provider (ISP). ISP connections over the local loop is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

Client 110 may include any number of applications, code modules, cookies, and the like to facilitate interaction with the various components of system 100 as shown, for example in FIG. 1. Such interaction may include for example, input data, complete templates/forms, view reports, validate data, approve data, review IP asset info, participate in a negotiation, review due diligence documents, respond to a survey, and the like. In various embodiments, client 110 may store user 105 preferences and/or any other information disclosed herein on a hard drive or any other local memory device. Accordingly, client 110 may retrieve and store consumer information within a memory structure of client 110 in the form of a browser cookie, for example. In various embodiments, client 110 retrieves information relating to user 105 from VTS 115 on establishing a session with Internet server 125.

Firewall 120, as used herein, may comprise any hardware and/or software suitably configured to protect VTS 115 components from users, other networks and systems. Firewall 120 may reside in varying configurations including stateful inspection, proxy based and packet filtering among others. Firewall 120 may be integrated as software within Internet server 125, any other VTS 115 components or may reside within another computing device or may take the form of a standalone hardware component. Although depicted as a single firewall in FIG. 1, one skilled in the art will recognize that a firewall or multiple firewalls may be implemented throughout system 100 and/or VTS 115 to enable system and data security.

Internet server 125 may include any hardware and/or software suitably configured to facilitate communications between client 110 and one or more VTS 115 components. Further, Internet server 125 may be configured to transmit data to client 110 within markup language documents (e.g., XML, HTML, etc.). As used herein, “data” may include encompassing information such as commands, queries, files, data for storage, and/or the like in digital or any other form. Internet server 125 may operate as a single entity in a single physical location or as separate computing components located together or in separate physical locations.

Internet server 125 may provide a suitable web site or other Internet-based graphical user interface which is accessible by consumers. In various embodiments, Internet server 125 employs RedHat Linux Enterprise 5.x Server and Apache Http server. In various embodiments, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Any of the communications, inputs, storage, databases or displays discussed herein may be facilitated through a web site having web pages. The term “web page” as it is used herein is not meant to limit the type of documents and applications that might be used to interact with the user. For example, a typical web site might include, in addition to markup language based documents (e.g., HTML), various forms, Java applets, JavaScript, active server pages (ASP), common gateway interface scripts (CM), extensible markup language (XML), dynamic HTML, cascading style sheets (CSS), helper applications, plug-ins, and/or the like. A server may include a web service that receives a request from a web server, the request including a URL (e.g. http://yahoo.com/stockquotes/ge) and an IP address (e.g. 123.4,56.789), The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

In order to control access to components of VTS 115, Internet server 125 may invoke authentication server 130 in response to user 105 submissions of authentication credentials received at Internet server 125 from client 110. Authentication server 130 may include any hardware and/or software suitably configured to receive authentication credentials, encrypt and decrypt credentials, authenticate credentials, and grant access rights according to privileges (e.g., pre-defined privileges) attached to the credentials. Authentication server 130 may grant varying degrees of application and data level access to users based on information stored within a database and/or any other known memory structure.

VTE 147 comprises hardware and/or software modules that execute processes, access data from CDR 150 and interact with workflow engine 148 to enable the functionality of VTS 115. For example, VTE 147 may receive a request to create a new account associated with VTS and may execute various automated processes to obtain and validate account data, create the account and to populate data on CDR 150.

Workflow engine 148 comprises hardware and/or software modules that implement process definition, tracking and execution. Workflow engine 148 may comprise one or more software applications, modules or data objects. The software may be any executable code written in any software programming language, such as, for example Java®. For example, workflow engine 148 reads data from CDR 150 and instantiates a data object (e.g. a Java Bean®) to store the data for use by software modules or other objects. In various embodiments, workflow engine 148 executes an automated or partially automated process such as a user account creation process, value transfer, user creation or deletion process, data population process, etc.

CDR 150 may include any hardware and/or software suitably configured to facilitate storing data relating to, for example, user accounts, user account identifiers, association of user account identifiers, pending transactions, transaction history, account balances, registration, transactions, account settings, user settings, etc.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the system includes special purpose computers, user interfaces (UIs), software modules, logic and/or workflow engines, numerous databases and computer networks. While the system may contemplate upgrades or reconfigurations of existing processing systems, changes to existing databases and system tools are not necessarily required by the system and method.

While the description references specific technologies, hardware, equipment, system architectures and data management techniques, practitioners will appreciate that this description merely discusses various embodiments and that other devices and/or methods may be implemented without departing from the scope of the disclosure. Thus, the detailed description herein is presented for purposes of illustration only and not of limitation. Similarly, while the description may reference a user interfacing with the system via a personal computer user interface, practitioners will appreciate that other interfaces may include mobile devices, smart phones, tablet computing devices, kiosks and handheld devices such as personal digital assistants.

One skilled in the art will appreciate that system 100 may employ any number of databases an any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of system 100, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with system 100 by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of system 100, the data may be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets, For example, the annotation may be called a “condition header”, “header”. “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in various embodiments, the header or trailer is not stored on the transaction device along with the associated issuer-owned data but instead the appropriate action may be taken by providing to the transaction instrument user at the stand-alone device, the appropriate option for the action to be taken. System 100 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 100 may consist of any combination thereof at a single location or at multiple locations, wherein each database or system 100 includes any of various suitable security features, such as firewalls, access codes, encryption, decryption, compression, decompression, and/or the like.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SKI), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

The invention may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices.

Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Software elements (e.g., modules, engines, etc.) may be implemented as a web service. In various embodiments, web services are implemented using Webservice Interoperability Organization Basic Profile 1.1.

Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory (or “computer-readable medium”) that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity, In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

System 100 combines unique app, integration, notification and value transfer features to enable a seamless value transfer services. While certain embodiments of the present invention are disclosed herein in terms of integration with a social networking service, practitioners will appreciate that the teachings of the present invention may be equally applicable interchangeably between any type of service or application that enable searching for or otherwise identifying the users of the system or service.

Referring again to FIG. 1, in various embodiments, in response to user 105 accessing VTS 115 (e.g., by logging onto an application or app), Internet server 125 may invoke an application server 145. Application server 145 invokes logic in VTE 147 by passing parameters relating to the user's 105 requests for data. VTS 115 manages requests for data from VTE 147 and communicates with system 101 components. Transmissions between user 105 and Internet server 125 may pass through a firewall 120 to help ensure the integrity of VTS 115 components. Practitioners will appreciate that the invention may incorporate any number of security schemes or none at all, In various embodiments, Internet server 125 receives requests from client 110 and interacts with various other system 100 components to perform tasks related to requests from client 110.

Internet server 125 may invoke an authentication server 130 to verify the identity of user 105 and assign roles, access rights and/or permissions to user 105. In order to control access to the application server 145 or any other component of VTS 115, Internet server 125 may invoke an authentication server 130 in response to user 105 submissions of authentication credentials received at Internet server 125. In response to a request to access system 100 being received from Internet server 125, Internet server 125 determines if authentication is required and transmits a prompt to client 110. User 105 enters authentication data at client 110, which transmits the authentication data to Internet server 125. Internet server 125 passes the authentication data to authentication server which queries the user database 140 for corresponding credentials. When user 105 is authenticated, user 105 may access various applications and their corresponding data sources.

VTS 115 enables user 105 (e.g., a user of social networking service 180) to configure, register for, transfer value, receive value, fund prepaid accounts, etc. In various embodiments, VTS 115 enables transferring value at the request of a user 105 (e.g. a purchaser) and while not requiring the user 105 to establish a permanent account with the value transfer service.

In various embodiments, VTS 115 enables a value transfer from a value sender to a value recipient. In various embodiments, the value transfer is a financial transaction where the value sender, or purchaser, responds to an offer by purchasing the offer from the value recipient (seller or merchant). For example, a merchant may register an offer on with an offer service. In an embodiment the value transfer service includes the functionality of an offer service. The merchant or seller configures the terms of the offer and the conditions upon which the offer should be distributed and/or accepted.

A purchaser may receive an offer. In various embodiments, the offer may be received from the value transfer service via, for example, email, a specialized app, a web page, a social networking service, etc.

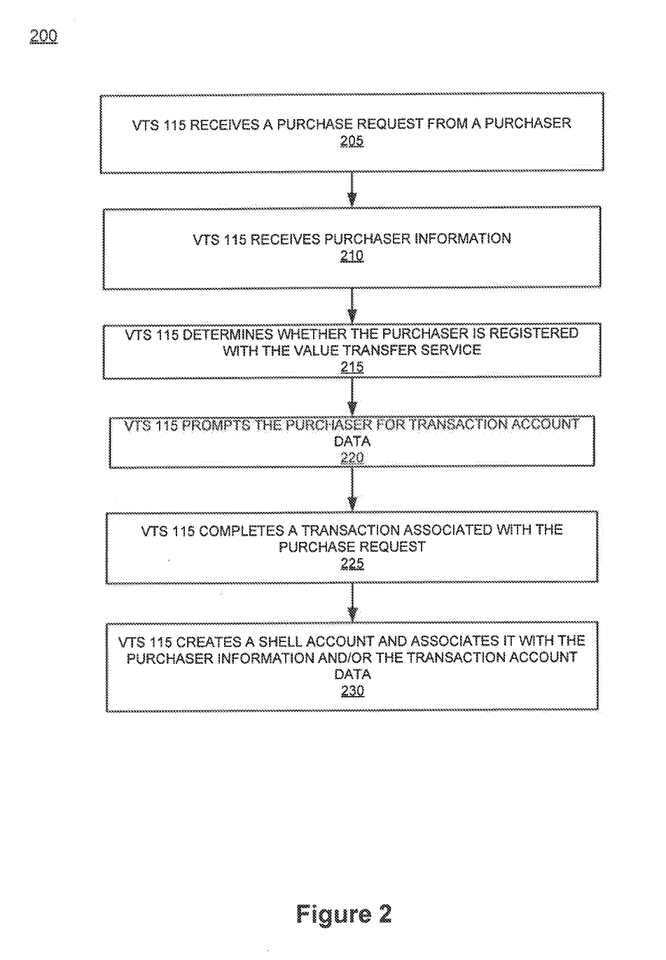

With reference now to FIG. 2, in various embodiments, VTS 115 receives a transaction request from a purchaser (Step 205). While the term “purchaser” may be used herein, the transaction is not limited to a purchase and the purchaser may be any person or entity conducting any type of transaction. The transaction request may relate to a purchase, lease, rent, loan, barter, access, rights, experience or any other transaction. In various embodiments, the transaction request is associated with an offer. For instance, the purchaser may respond to an email by clicking on a link in order to take advantage of the offer. VTS 115 may prompt the user for purchaser information. In an embodiment, VTS 115 may prompt the purchaser for purchaser information. Purchaser information may include, for example, first name, last name and email address, VTS 115 receives the purchaser information (Step 210).

In response to the receiving the transaction request, in various embodiments, VTS 115 may determine that the transaction request is associated with a transaction value greater than a threshold amount and prompt the purchaser to complete an account registration process in order to complete the purchase transaction. In response to the receiving the transaction request, in various embodiments, VTS 115 may determine that a transaction account associated with the transaction request has been previously used to complete a transaction and prompt the purchaser to complete an account registration process in order to complete the purchase transaction.

VTS 115 determines whether the purchaser is registered with the value transfer service (Step 215). In various embodiments, VTS may determine whether the user is registered by matching registration information associated with a fully functional VTS account with purchaser information. In various embodiments, the purchaser is associated with a full account in the value transfer service and VTS 115 prompts the user to login using the login credentials associated with the account. The purchaser may be associated with a shell account and VTS 115 prompts the user to register for a full account as part of the purchasing of the offer.

If the purchaser is not associated with a full account or a shell account, in various embodiments, VTS prompts the purchaser for transaction account data (Step 220) and in response to receiving transaction account data, completes a transaction associated with the transaction request (Step 225). VTS 115 creates a shell account and associates the shell account with at least one of the purchaser information and the transaction account data (Step 230). In various embodiments, VTS 115 prompts the purchaser asking whether the purchaser wishes to register for a full account with the value transfer service. VTS 115 prompts the purchaser asking whether the purchaser wishes to save the transaction account (e.g. credit card) information in a shell account. For more information regarding information associated with opening a financial account and rules and processes associated with various levels of accounts, see U.S. patent application Ser. No. 12/986,967 entitled “Financial Account Onboarding,” filed on Jan. 7, 2011 which is hereby incorporated by reference in its entirety.

In various embodiments, VTS 115 receives a registration request from the purchaser. For example, as discussed with reference to FIG. 2 herein, a purchaser may respond to an offer and purchase the offer, but fail to register for a full account with the value transfer service. VTS 115 may, in various embodiments, create a shell account for the purchaser. A shell account is useful because it enables VTS 115 to follow up with the customer to, for example, extend further offers and incentives and/or reminders to complete a full registration with the value transfer service. Furthermore, the shell account enables VTS 115 to prepopulate (e.g., autopopulate) data during the full registration process.

In various embodiments, VTS 115 may send a reminder to the purchaser. A reminder may be generated in response to a time frame expiring, in response to an event, in response to a contact or request from the user, etc. For example, VTS 115 may auto-generate a reminder and send the reminder to a user associated with a shell account (e.g. a purchaser that completed a purchase transaction) if the shell account associated with the purchaser is more than seven days old. In various embodiments, VTS 115 may send a reminder to the purchaser to “convert” the shell account into a full account by way of sending the purchaser a second offer. The purchaser responds to a second offer and VTS 115 requires the purchaser to complete a full registration in order to take advantage of the second offer.

In various embodiments, VTS 115 may generate a uniform resource locator (i.e. a link) and/or a token and include it in the reminder. For example, a registration reminder may comprise an email message comprising a registration token. In various embodiments, the registration request may be received in response to a user selecting the registration token.

In various embodiments, VTS 115 receives a request to purchase and offer from a purchaser. VTS 115 determines, based upon request information included in the request that a shell account in VTS (e.g. stored in CDR 150) matches information included in the request. For example, email addresses may match, transaction account numbers may match, last names may match etc. VTS 115 may validate the registration information by analyzing at least one of transaction account information and billing address to determine a match with shell account information associated with the shell account. VTS 115 prepopulates a registration interface with at least a portion of information associated with the shell account and presents the registration interface to the purchaser (i.e. user 105), VTS 115 receives registration information from the purchaser, validates the information and/or creates a full account in the value transfer service for the purchaser.

In various embodiments, VTS 115 converts a shell account to a full VTS account (as described herein) and VTS 115 associates transaction information of the shell account with the full account. VTS 115 queries CDR 150 to determine if there are any historical transactions associated with the shell account that is being converted. In various embodiments, upon determining that historical transactions exist, VTS 115 prompts user 105 to determine whether the user wishes to associate the historical transactions with the full VTS account that is being created for the user.

Systems, methods and computer program products are provided. In the detailed description herein, references to “various embodiments”, one embodiment“, an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when as particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more,” Moreover, where a phrase similar to ‘at least one of A, B, or C’ is used in the claims or specification, it is intended that the phrase be interpreted to mean that A alone may be present in various embodiments, B alone may be present in various embodiments, C alone may be present in various embodiments, or that any combination of the elements A, B and C may be present in a single embodiment; for example, A and B, A and C, B and C, or A and B and C. All structural, chemical, and functional equivalents to the elements of the above-described exemplary embodiments that are known to those of ordinary skill in the art are expressly incorporated herein by reference and are intended. to be encompassed by the present claims. Further, a list of elements does not include only those elements but may include other elements not expressly listed or inherent to such process, method, article, or apparatus.

1. A computer-based method comprising:
receiving, by a value transfer computer associated with a value transfer service, a first transaction request from a purchaser, wherein the transaction request is associated with a first offer;
receiving, by the computer, purchaser information comprising a purchaser name and a purchaser email;
determining, by the computer, that the purchaser is not registered with the value transfer service;
in response to the determining that the purchaser is not registered, prompting, by the computer, the purchaser for transaction account data;
in response to receiving transaction account data, completing, by the computer, a transaction associated with the first transaction request; and
associating, by the computer, a shell account with at least one of the purchaser information and the transaction account data.

2. The method of claim 1, further comprising receiving a registration request from the purchaser and prompting the purchaser to complete an account registration process.

3. The method of claim 2, wherein the registration request is received in response to sending a registration reminder to the purchaser.

4. The method of claim 3, wherein the registration reminder comprises an email message comprising a registration token.

5. The method of claim 4, wherein the registration request comprises the registration token and the registration request is received in response to a user selecting the registration token.

6. The method of claim 2, wherein the prompting the purchaser to complete the account registration process is in response to at least one of a time limit being exceeded, an event occurring and a contact from the purchaser.

7. The method of claim 6, wherein the contact from the purchaser comprises receiving a second transaction request from the purchaser.

8. The method of claim 2, further comprising, determining requestor information based upon the registration request and determining that the registration request is associated with the shell account of the purchaser.

9. The method of claim 8, further comprising prepopulating a registration interface with shell account information associated with the shell account to create a prepopulated registration interface, wherein the prompting the purchaser to complete an account registration process comprises presenting the user with the prepopulated registration interface.

10. The method of claim 9, further comprising receiving registration information from the purchaser and creating a full account for the purchaser.

11. The method of claim 10, further comprising:
querying, by the computer, a transaction history database associated with the value transfer service to identify transaction information associated with at least one of the shell account and the purchaser; and
associating, by the computer, the transaction information with the full account.

12. The method of claim 10, further comprising validating the registration information by analyzing at least one of transaction account information and billing address to determine a match with shell account information associated with the shell account.

13. The method of claim 1, further comprising;
receiving, by the computer, a second transaction request;
determining, by the computer, that the second transaction request is associated with a user that has completed at least one purchase transaction; and
in response to the determining that the second transaction request is associated with the user, by the computer, prompting the purchaser to complete an account registration process.

14. The method of claim 13, wherein the user is the purchaser and wherein the determining that the purchase has completed at least one purchase transaction comprises matching second transaction request information with shell account information associated with the shell account of the purchaser.

15. The method of claim 1, further comprising, in response to the receiving the transaction request, determining that the transaction request is associated with a transaction value greater than a threshold amount and prompting the purchaser to complete an account registration process.

16. The method of claim 1, further comprising receiving first offer information associated with the first offer from a merchant.

17. The method of claim 1, further comprising:
prompting, by the computer, the user as to whether the user wants to save the transaction account data, wherein the user replies indicating that the transaction account data should be saved; and
saving, by the computer, the transaction account data and associating it with the shell account.

18. A system comprising:
a value transfer processor associated with a value transfer service;
a tangible memory configured to communicate with the processor, the memory having instructions stored thereon that, in response to execution by the processor, cause the processor to be capable of performing operations comprising:
receiving, by the processor associated with a value transfer service, a first transaction request from a purchaser, wherein the transaction request is associated with a first offer;
receiving, by the processor, purchaser information comprising a purchaser name and a purchaser email;
determining, by the processor, that the purchaser is not registered with the value transfer service;
in response to the determining that the purchaser is not registered, prompting, by the processor, the purchaser for transaction account data;
in response to receiving transaction account data, completing, by the processor, a transaction associated with the first transaction request; and
associating, by the processor, a shell account with at least one of the purchaser information and the transaction account data.

19. An article of manufacture including a non-transitory, tangible computer readable storage medium having instructions stored thereon that, in response to execution by a value transfer computer associated with a value transfer service, cause the value transfer computer to be capable of performing operations comprising:
receiving, by the computer, a first transaction request from a purchaser, wherein the transaction request is associated with a first offer;
receiving, by the computer, purchaser information comprising a purchaser name and a purchaser email;
determining, by the computer, that the purchaser is not registered with the value transfer service;
in response to the determining that the purchaser is not registered, prompting, by the computer, the purchaser for transaction account data;
in response to receiving transaction account data, completing, by the computer, a transaction associated with the first transaction request; and
associating, by the computer, a shell account with at least one of the purchaser information and the transaction account data.
